(19) United States
(12) Patent Application Publication
(10) Pub. No.: US 2009/0116932 A1
(43) Pub. Date: May 7, 2009

(54) Process for Producing Molded Article with Undercut, Forging Apparatus Therefor, and Intermediate Molded Object

(75) Inventors: Takashi Kihara, Tochigi-ken (JP); Takeshi Shiraishi, Tochigi-ken (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: HONDA MOTOR CO., LTD., Tokyo (JP)

(21) Appl. No.: 11/991,646

(22) PCT Filed: Sep. 14, 2006
(86) PCT No.: PCT/JP2006/318259

§ 371 Date: Mar. 7, 2008

(30) Foreign Application Priority Data
Sep. 16, 2005 (JP) 2005-270462
Sep. 16, 2005 (JP) 2005-270492
Mar. 20, 2006 (JP) 2006-077147

(51) Int. Cl. F16B 33/00; B21D 22/00; B21J 5/00

(52) U.S. Cl. 411/369; 72/356; 72/354.2

(57) ABSTRACT

First upsetting is conducted in which an annular sidewall part is plastically deformed outward in the radial directions by a first molding part of a punch to thereby form a first-upsetting molded part on one end. Subsequently, second upsetting is conducted in which a solid part is pressed with the punch and the solid part is plastically deformed outward in the radial directions by a split mold which is descending. Thus, the plastically deformed part comes into and fills a second molding part of the split mold to form a second-upsetting molded part on the other end in the axis direction. Simultaneously therewith, an undercut part is formed between the first-upsetting molded part and the second-upsetting molded part by an undercut-molding part of the split mold.

### TECHNICAL FIELD

The present invention relates to a method of manufacturing a formed article with an undercut (process for producing a molded article with an undercut) by forging a forging blank or an intermediate form (intermediate molded object) into a formed article which includes a first upset portion and a second upset portion respectively on axially opposite ends thereof and an undercut between the first upset portion and the second upset portion, a forging apparatus for manufacturing such a formed article, and an intermediate form (intermediate molded object) therefor.

### BACKGROUND ART

Heretofore, it has been known to manufacture a member with an undercut by forging.

For example, Japanese Laid-Open Patent Publication No. 2002-346683 discloses a lower die for supporting a radially outer side of a member to be formed, the lower die being circumferentially separated into a plurality of parts and having an abutment surface on an axial end thereof and an annular ridge projecting radially inwardly complementarily in shape to an undercut, and an upper die having a seat surface engageable with the abutment surface, the upper die being axially fittable radially outwardly over the lower die from the abutment surface and being capable of tightening the lower die radially inwardly from a radially outer side thereof.

Japanese Laid-Open Patent Publication No. 09-239740 discloses a die apparatus comprising a movable plate having a split die knockout pin and a knockout pin, and a guide mechanism for guiding split dies at a predetermined angle with respect to the direction in which the split dies are movable. The split dies are opened and a formed article is ejected simultaneously in a single cycle of operation to reduce the time required to release the formed article for increased operating efficiency.

Japanese Laid-Open Patent Publication No. 06-114486 discloses a toothed formed product in the shape of a hollow cylinder with a central through hole defined therein, the toothed formed product having radially outwardly projecting annular flanges disposed respectively on axially opposite ends thereof, with teeth disposed on the outer circumferential surface of one or the other of the annular flanges.

According to the technical concepts disclosed in Japanese Laid-Open Patent Publication No. 2002-346683, Japanese Laid-Open Patent Publication No. 09-239740, and Japanese Laid-Open Patent Publication No. 06-114486, however, a single forging process (upsetting process) can form a single bulging upset portion only, and it is difficult to produce, in a single upsetting process, a formed article including a first upset portion and a second upset portion that are substantially simultaneously formed respectively on axially opposite ends and an undercut between the first upset portion and the second upset portion.

It may be proposed to use a first movable punch and a second movable punch that are disposed coaxially with each other and to axially press a member to be formed that is sandwiched between the first movable punch and the second movable punch in directions to bring them toward each other, thereby forming a first bulging upset portion and a second bulging upset portion respectively on axially opposite ends.

However, two drive mechanisms for actuating the first movable punch and the second movable punch respectively may be required, and pressing forces from the first movable punch and the second movable punch have to be controlled to adjust the amounts of flowing material distributed to the first bulging upset portion and the second bulging upset portion.

### DISCLOSURE OF THE INVENTION

It is a general object of the present invention to provide a method of manufacturing a formed article with an undercut comprising a first upset portion and a second upset portion respectively on axially opposite ends and an undercut between the first upset portion and the second upset portion, according to a single forging process which requires no adjustment for distributed amounts of flowing material, a forging apparatus for manufacturing such a formed article, and an intermediate form therefor.

First, a cylindrical billet is pressed and machined by a backward extrusion process to form an intermediate form comprising a hollow cylindrical annular side wall extending a predetermined length along an axial direction thereof and a cylindrical solid body contiguous to the annular side wall.

According to the present invention, the intermediate form is used as a member to be formed, and the member to be formed is placed in a cavity defined by a plurality of split dies floatingly biased by a biasing mechanism and a lower die serving as a fixed die.

Then, a punch is lowered to perform a first upsetting process to cause a first forming portion of the punch to plastically deform the annular side wall of the member to be formed radially outwardly while the split dies surrounding the member to be formed are being lowered, thereby forming a first upset portion on an axial end of the member to be formed.

Then, the punch is further lowered to perform a second upsetting process to cause the punch to abut against and press the solid body of the member to be formed, so as to plastically deform the solid body radially outwardly while the split dies surrounding the member to be formed are being lowered. In the second upsetting process, a plastically deformed material of the solid body is caused to flow into and fill second forming portions of the split dies, thereby forming a second upset portion on an axial other end of the member to be formed, and causing undercut forming portions of the split dies to form an undercut between the first upset portion and the second upset portion.

According to the present invention, as described above, the member to be formed is placed in a floating state by the split dies biased by the biasing mechanism, and a simple process is performed by axially pressing the member to be formed with the single punch, so as to form a first and second upset portions. According to the simple process, a formed body is produced which includes the first upset portion and the second upset portion which are substantially simultaneously formed respectively on the axially opposite ends thereof and the undercut disposed between the first upset portion and the second upset portion.

A material flow is distributed between the first upset portion and the second upset portion by the undercut forming portions of the split dies which abut against a boundary region between the annular side wall and the solid body of the member to be formed.

The simple process of axially pressing the member to be formed with the single punch thus makes it possible to produce the formed body which includes the first upset portion and the second upset portion which are disposed respectively on the axially opposite ends thereof and the undercut disposed between the first upset portion and the second upset portion.

In order to produce the formed body which has the undercut disposed between the first upset portion and the second upset portion, the member to be formed may comprise a hollow cylinder including an upper annular side wall extending a predetermined length parallel to an axial direction thereof and a lower annular side wall contiguous to the upper annular side wall, the hollow cylinder having a constant outside diameter along the axial direction.

### BRIEF DESCRIPTION OF THE DRAWINGS

FIGS. 1A through 1E are vertical cross-sectional views showing a process of manufacturing a transmission gear to which a method of manufacturing a formed article with an undercut according to an embodiment of the present invention is applied;

FIGS. 2A through 2F are vertical cross-sectional views showing the manner in which a member to be formed is deformed by upsetting in the method of manufacturing a formed article with an undercut according to the embodiment of the present invention;

FIG. 3 is an axial vertical cross-sectional view of a forging apparatus according to an embodiment of the present invention;

FIG. 4 is a plan view of four circumferentially split dies, which are closed, of the forging apparatus shown in FIG. 3;

FIG. 5 is a plan view of the split dies shown in FIG. 4, which are open;

FIG. 6 is a vertical cross-sectional view showing the forging apparatus in which a punch is actuated to plastically deform a member to be formed into a tertiary form having a first upset portion and a second upset portion;

FIG. 7 is a vertical cross-sectional view showing the forging apparatus in which the split dies are open and the formed member is lifted;

FIG. 8 is a vertical cross-sectional view of split dies according to a modification;

FIG. 9 is a vertical cross-sectional view of the split dies shown in FIG. 8, which are open;

FIG. 10 is an enlarged fragmentary vertical cross-sectional view of an undercut forming portion of a split die of the forging apparatus shown in FIG. 3, the view showing a material flow distributing point between the first upset portion and the second upset portion;

FIG. 11 is an enlarged fragmentary vertical cross-sectional view of a modification of the undercut forming portion shown in FIG. 10;

FIG. 12 is an enlarged fragmentary vertical cross-sectional view illustrative of a material filling condition for a second forming portion of a split die;

FIGS. 13A through 13C are vertical cross-sectional views showing a process of manufacturing a transmission gear to which a method of manufacturing a formed article with an undercut according to another embodiment of the present invention is applied;

FIGS. 14A through 14F are vertical cross-sectional views showing the manner in which a member to be formed is deformed by upsetting in the method of manufacturing a formed article with an undercut according to the other embodiment of the present invention; and

FIG. 15 is an enlarged vertical cross-sectional view showing a pipe to be formed and the pipe which has been formed, for comparison, the view showing that there is no material flow between a first upset portion and a second upset portion across an undercut forming portion as a boundary.

### BEST MODE FOR CARRYING OUT THE INVENTION

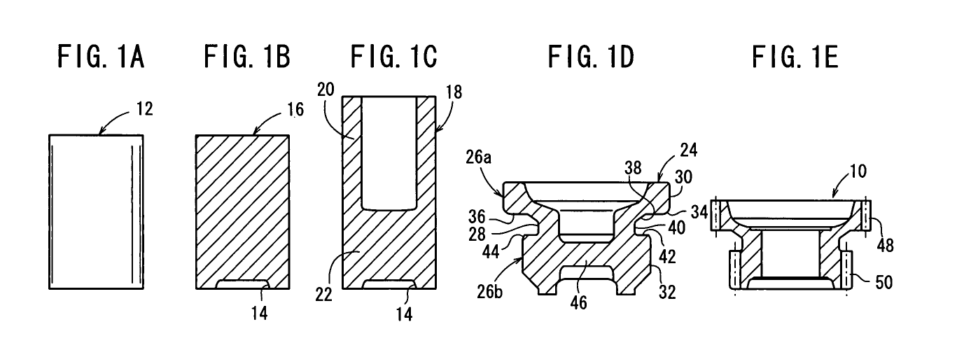

FIGS. 1A through 1E show a process of manufacturing a transmission gear 10 to which a method of manufacturing a formed article with an undercut according to an embodiment of the present invention is applied.

The transmission gear 10 is manufactured through a plurality of steps described below. The steps shown in FIGS. 1A through 1D should preferably be performed by warm or hot forging.

A billet comprising a cylindrical body 12 shown in FIG. 1A is machined in a preliminary step into a preform 16 (see FIG. 1B) with a positioning recess 14 defined in the bottom of the billet. Thereafter, the preform 16 is machined by a backward extrusion process using a first forging apparatus, not shown, thereby producing a primary form (intermediate form) 18 (see FIG. 1C).

The primary form 18 has, on an axial end thereof, a thin, hollow cylindrical annular side wall 20 extended a predetermined length parallel to the axial direction by the backward extrusion process, and also has, on the other axial end, a cylindrical solid body 22 contiguous to the annular side wall 20 and similar to the preform 16.

Then, the primary form 18, which serves as a member to be formed, is upset by a second forging apparatus 60, to be described later, according to an embodiment of the present invention, thereby producing a secondary form (formed article) 24 shown in FIG. 1D.

The secondary form 24 has a first upset portion 26a and a second upset portion 26b which are disposed respectively on axially opposite ends thereof and expand a predetermined length radially outwardly, and an undercut 28 disposed between the first upset portion 26a and the second upset portion 26b and defined as an annular recess which is recessed a predetermined length radially inwardly. The first upset portion 26a on one of the axially opposite ends has a side wall 30 which is greater in outside diameter than a side wall 32 of the second upset portion 26b on the other of the axially opposite ends.

The undercut 28 is defined by a round corner 34 having a curved cross-sectional shape contiguous to the side wall 30 of the first upset portion 26a, a substantially flat first annular wall surface 36 extending from the round corner 34 along a horizontal direction substantially perpendicular to the axial direction, a tapered surface 38 inclined a predetermined angle to the first annular wall surface 36 and progressively smaller in diameter toward the second upset portion 26b, a second annular wall surface 40 contiguous to the tapered surface 38 and extending substantially parallel to the axial direction, and a substantially flat third annular wall surface 42 contiguous to the second annular wall surface 40 and extending along a horizontal direction substantially perpendicular to the axial direction.

The third annular wall surface 42 is contiguously joined through a round corner 44 to the side wall 32 of the second upset portion 26b.

Then, after a solid portion 46 of the secondary form 24 is pierced by a third forging apparatus, not shown, the side walls 30, 32 of the first and second upset portions 26a, 26b are machined into respective first and second gears 48, 50. The entire body is now available as the transmission gear 10 (see FIG. 1E), as a product.

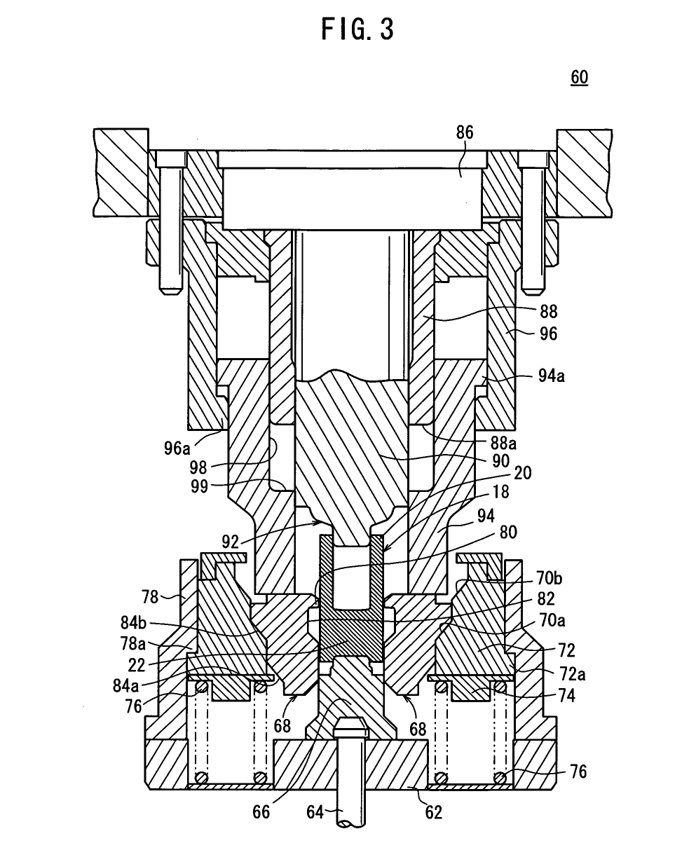

The second forging apparatus 60 according to the embodiment of the present invention is shown in FIGS. 3 through 7.

The second forging apparatus 60 upsets the primary form 18 shown in FIG. 1C which serves as a member to be formed.

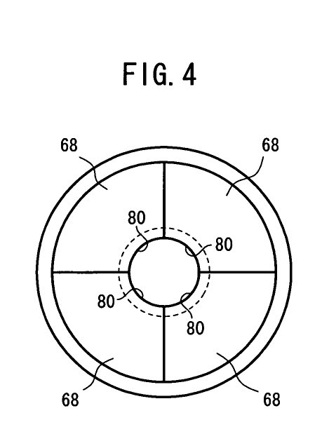

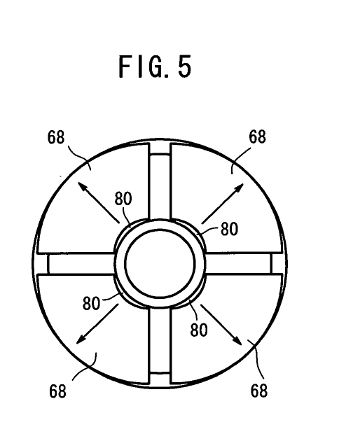

The second forging apparatus 60 comprises a die base 62, a knockout pin 64 vertically displaceable through a through hole defined centrally in the die base 62 by an actuator, not shown, a lower die 66 disposed on the die base 62 and coupled to a distal end of the knockout pin 64 for vertical movement with the knockout pin 64, and four substantially equally circumferentially split dies 68 (see FIGS. 4 and 5) disposed laterally closely to the lower die 66 in surrounding relation to the member to be formed, the split dies 68 being separable from the formed member when they are open.

The second forging apparatus 60 also includes a guide die member 72 having, on its inner wall, a tapered first annular guide surface 70a and a tapered second annular guide surface 70b for guiding the four split dies 68 radially outwardly and upwardly when the split dies 68 are open, a support base 74 supporting the guide die member 72 thereon, spring members 76 disposed below the guide die member 72 and functioning as a biasing mechanism for floatingly supporting the four split dies 68 through the guide die member 72, and a lateral die member 78 in the form of a hollow cylinder surrounding the outer circumferential surface of the guide die member 72 and having, on its inner wall, an annular step 78a for abutting against an annular ridge 72a of the guide die member 72 to limit the guide die member 72 against upward movement.

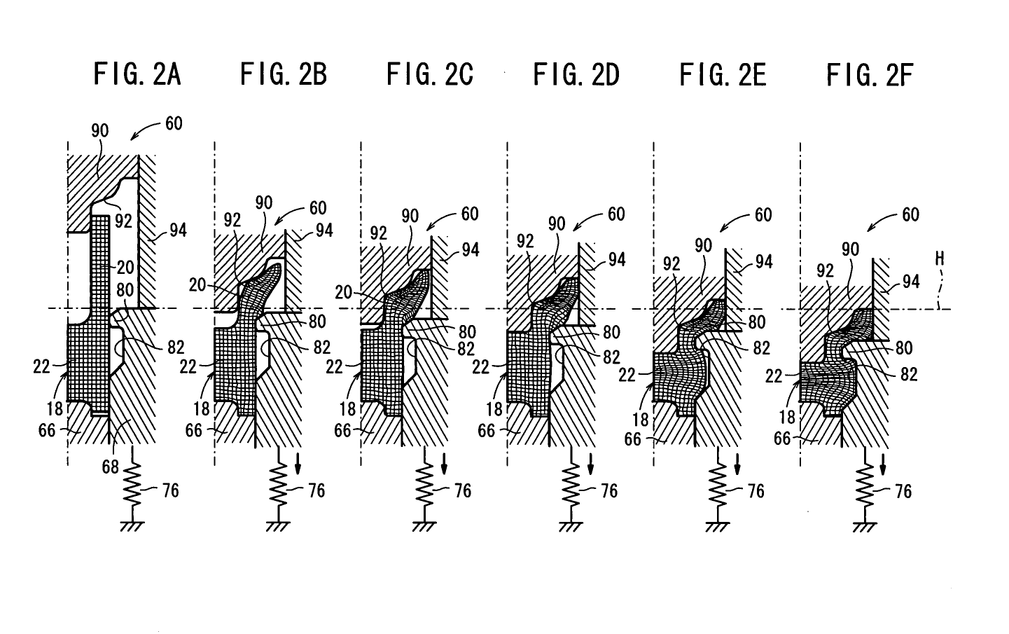

The split dies 68 are made vertically displaceable by the biasing mechanism which is in the form of the spring members 76 disposed below the guide die member 72. As shown in FIG. 2A, when no load is applied to the split die 68, each split die 68 has an upper surface aligned with a dot-and-dash line H in an initial position. The biasing mechanism is not limited to the spring members which may be coil springs, leaf springs, or the like for exerting resilient forces, but may be a damping mechanism such as gas springs or the like, a pressure fluid, or the like, for example.

Each split die 68 has, on its inner wall near the lower die 66, an undercut forming portion 80 in the form of an annular ridge projecting radially inwardly (in substantially the horizontal direction) for abutting against the boundary region between the annular side wall 20 and the solid body 22 of the primary form 18, and a second forming portion 82 in the form of an annular recess contiguous to and disposed below the undercut forming portion 80 for plastically deforming the solid body 22 of the primary form 18 radially outwardly into the second upset portion 26b.

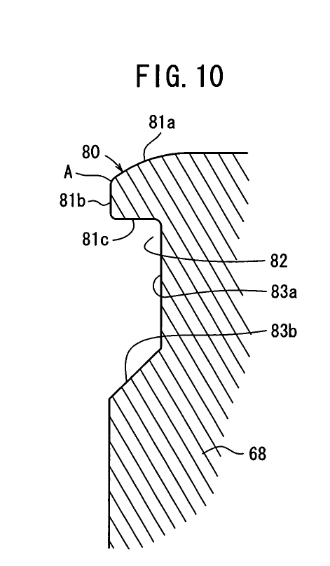

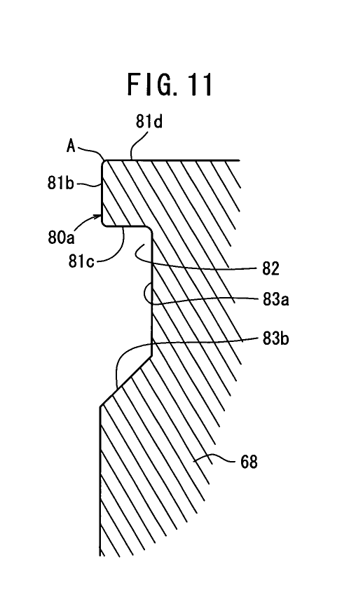

As shown in FIG. 10, the undercut forming portion 80 comprises a curved portion 81a having an arcuate cross section, an abutting portion 81b contiguous to the curved portion 81a for abutting against the member to be formed, and a horizontal portion 81c disposed below the abutting portion 81b and extending substantially horizontally. Between the curved portion 81a and the abutting portion 81b, there is a distributing point A for distributing a material flow into the first upset portion 26a and the second upset portion 26b, as described later. As indicated by a modification shown in FIG. 11, the split die 68 may have an upper flat surface 81d with an undercut forming portion 80a having a distributing point A disposed at a beveled corner of the upper flat surface 81d.

As shown in FIG. 10, the second forming portion 82 is disposed below the undercut forming portion 80. The second forming portion 82 comprises a horizontal surface provided by the horizontal portion 81c, a vertical surface 83a perpendicular to the horizontal surface, and a slanted surface 83b inclined at a prescribed angle to the vertical surface 83a.

As shown in FIG. 3, each split die 68 has, on its outer side wall, a first annular slanted surface 84a and a second annular slanted surface 84b, which comprise respective tapered surfaces corresponding respectively to the first annular guide surface 70a and the tapered second annular guide surface 70b of the guide die member 72, for engaging the first annular guide surface 70a and the second annular guide surface 70b, respectively.

The second forging apparatus 60 also includes a vertically movable member 86 which is vertically movable in response to operation of a ram, not shown, a punch holder 88 fixed to the vertically movable member 86 and fitted over a punch, to be described below, and a punch 90 vertically movable in unison with the vertically movable member 86 by the punch holder 88. The punch 90 has on its distal end a first forming portion 92 for plastically deforming the annular side wall 20 of the primary form 18 into the first upset portion 26a.

A hollow cylindrical sleeve 94 for abutting against the upper surfaces of the split dies 68 upon forging to limit the outside diameter of the first upset portion 26a is fitted over the punch 90. The sleeve 94 is displaceable along the axial direction of the punch 90 by a holder 96 fixed to the vertically movable member 86.

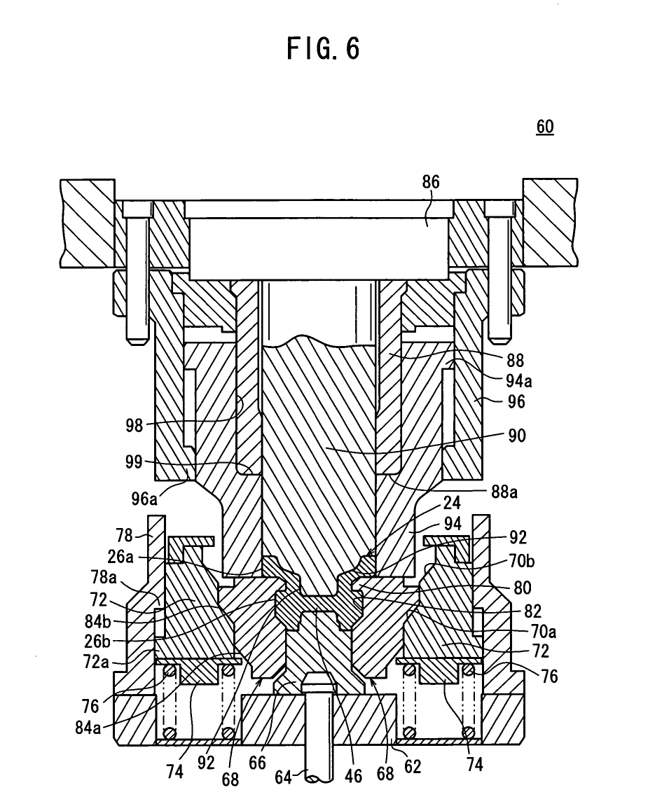

The sleeve 94 has an annular ridge 94a disposed on the outer surface of the upper end thereof for abutting against an annular ridge 96a on the inner surface of the lower end of the holder 96 to prevent the sleeve 94 from being dislodged from the punch 90. The sleeve 94 also has an annular recess 98 defined in an inner wall thereof and having a bottom surface 99. When the lower end 88a of the punch holder 88 abuts against the bottom surface 99 (see FIG. 6), the punch 90 is limited against downward movement and reaches a bottom dead center.

The second forging apparatus 60 according to the present embodiment is basically constructed as described above. Operation and advantages of the second forging apparatus 60 will be described in detail below with reference to FIGS. 2A through 2F.

First, the primary form 18 shown in FIG. 1C is placed in a cavity defined by the lower die 66 and the four split dies 68. Then, a vertically moving mechanism, not shown, is actuated to lower the punch 90 in unison with the vertically movable member 86 until, as shown in FIG. 2A, the first forming portion 92 on the distal end surface of the punch 90 engages the annular side wall 20 of the primary form 18 (see FIG. 3).

At this time, the undercut forming portions 80 of the split dies 68 are held in abutment against the boundary region between the annular side wall 20 and the solid body 22 on the outer surface of the primary form 18. The split dies 68 are not displaced downwardly, but are biased into the initial position by the biasing mechanism in the form of the spring members 76.

Then, as shown in FIGS. 2B and 2C, when the punch 90 is further lowered toward the lower die 66, the first forming portion 92 of the punch 90 starts a first upsetting process to spread the annular side wall 20 of the primary form 18 obliquely and radially-outwardly from the undercut forming portion 80. A material flow is now distributed into the first upset portion 26a and the second upset portion 26b from the region (distributing point A) which is contacted by the undercut forming portion 80.

In the first upsetting process, the annular side wall 20 of the primary form 18 is plastically deformed complimentarily in shape to the first forming portion 92, thereby forming the first upset portion 26a on one end. As shown in FIGS. 2B, and 2C, each split die 68 is gradually lowered depending on a balance between the amount of deformation (extent of deformation) of the first upset portion 26a under the pressing force of the punch 90 and a forming force of the solid body 22 which has started to slightly spread radially outwardly into the second forming portion 82 under the pressing force of the punch 90.

Then, as shown in FIGS. 2D and 2E, when the punch 90 is further lowered toward the lower die 66, and the distal end of the punch 90 abuts against and presses the solid body 22 of the primary form 18, a second upsetting process is performed to compress and plastically deform the solid body 22 radially outwardly.

Specifically, as the distal end of the punch 90 presses the solid body 22 of the primary form 18 downwardly, a reactive force is generated to push the solid body 22 of the primary form 18 held by the lower die 66 upwardly in the direction opposite to the direction in which the solid body 22 is pressed by the punch 90. Under the reactive force, the bulging of the plastically deformed material is accelerated toward the second forming portions 82, in the form of annular recesses, of the split dies 68 (see FIGS. 2D and 2E).

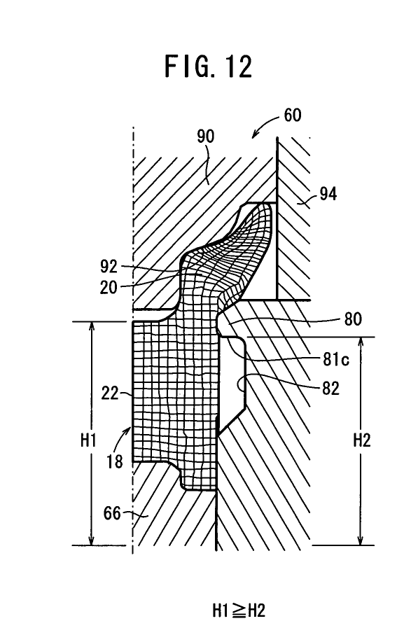

In order for the plastically deformed material to flow smoothly into and fill the entire second forming portions 82 of the split dies 68, it is necessary that, as shown in FIG. 12, the vertical height H1 of a surface on the boundary between the annular side wall 20 and the solid body 22 of the member to be formed be greater than or at least equal to the vertical height H2 of the horizontal surface 81c of the undercut forming portion 80 (H1≧H2). The vertical heights H1, H2 refer to vertical heights from a lower common reference surface which is established as desired. FIG. 12 shows a state immediately before the material starting to be plastically deformed flows into the second forming portions 82 of the split dies 68.

Then, as shown in FIG. 2F, in the second upsetting process performed on the solid body 22 of the primary form 18 upon further downward movement of the punch 90 toward the lower die 66, the plastically deformed material flows into and fills the entire second forming portions 82, in the form of annular recesses, of the split dies 68, thereby forming the second upset portion 26b on the other end (see FIG. 6).

As a result, as shown in FIG. 1D, the secondary form 24 is produced which has the first upset portion 26a and the second upset portion 26b which are disposed respectively on the axially opposite ends thereof and expand a predetermined length radially outwardly, and the undercut 28 disposed between the first upset portion 26a and the second upset portion 26b.

The split dies 68 are held in a prescribed position where a first upsetting force and a second upsetting force are in a state of balance. Specifically, the split dies 68 held in a floating state by the biasing mechanism in the form of the spring members 76 are gradually lowered depending on the amount of deformation of the first upset portion 26a that is produced when the annular side wall 20 is plastically deformed under the pressing force of the punch 90 and the amount of deformation of the second upset portion 26b that is produced when the solid body 22 is slightly expanded under the pressure of the punch 90. Thereafter, the split dies 68 are held in the prescribed position when the first upsetting force tending to plastically deform the annular side wall 20 and the second upsetting force tending to plastically deform the solid body 22 are brought into a state of balance (see FIG. 2F).

The balanced position of the split dies 68 is preset according to forging conditions including a standby position of the punch 90, the pressing force of the punch 90, etc. The balanced position of the split dies 68 is finally established such that the formed article has its dimensions determined when the punch 90 reaches the bottom dead center upon abutment of the lower end 88a of the punch holder 88 against the bottom surface 99 of the annular recess 98 defined in the inner wall of the sleeve 94 immediately before the completion of the forming process.

Then, the four split dies 68 are pushed upwardly by a pressing mechanism, not shown. The first annular slanted surface 84a and the second annular slanted surface 84b on the outer side wall of each split die 68 are guided respectively along the first annular guide surface 70a and the second annular guide surface 70b of the guide die member 72. Therefore, as the split dies 68 move upwardly radially outwardly, the undercut forming portions 80 and the second forming portions 82 of the split dies 68 are separated from the formed article, whereupon the die opening process is completed.

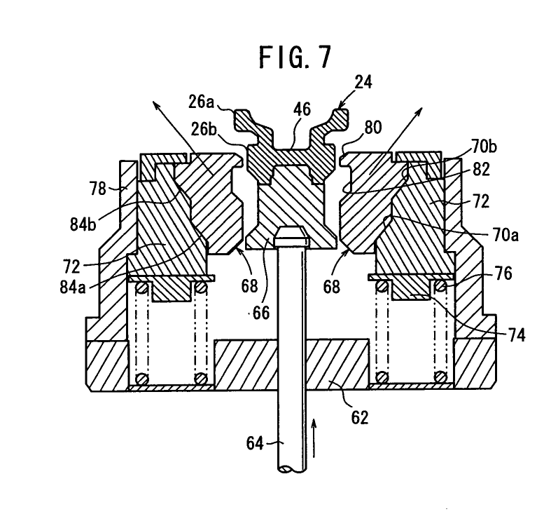

Stated otherwise, when the upsetting process is performed, only the first annular guide surface 70a on the lower portion of the inner wall of the guide die member 72 and the second annular slanted surfaces 84b on the upper portions of the side walls of the split dies 68 engage each other. As the split dies 68 move upwardly radially outwardly, the first annular guide surface 70a and the second annular guide surface 70b of the guide die member 72 engage the first annular slanted surfaces 84a and the second annular slanted surfaces 84b of the split dies 68, respectively, whereupon the split dies 68 are opened (see FIG. 7).

Then, the knockout pin 64 is lifted in unison with the lower die 66 by the actuator, not shown, to elevate the formed article from the center of the split dies 68. The formed article is gripped by a gripping mechanism, not shown, and transferred to a next process.

According to the present embodiment, the member to be formed is placed in a displaceable state by the split dies 68 biased by the biasing mechanism in the form of the spring members 76, and a single upsetting process is performed by axially pressing the member to be formed (the primary form 18) with the single punch 90 to produce the first and second upset portions. According to the single upsetting process, the formed article (secondary form 24) is produced which includes the first upset portion 26a and the second upset portion 26b which have been substantially simultaneously formed respectively on the axially opposite ends thereof and the undercut 28 disposed between the first upset portion 26a and the second upset portion 26b.

The material flow is distributed between the first upset portion 26a and the second upset portion 26b from the distributing point A (see FIGS. 10 and 11) of the undercut forming portions 80 of the split dies 68 which abut against the boundary region between the annular side wall 20 and the solid body 22 of the member to be formed.

In the present embodiment, when the split dies 68 are opened, the first annular guide surface 70a and the second annular guide surface 70b of the guide die member 72 engage the first annular slanted surfaces 84a and the second annular slanted surfaces 84b, respectively, of the split dies 68 to cause the split dies 68 to move upwardly radially outwardly. However, the split dies may be moved radially outwardly according to another process.

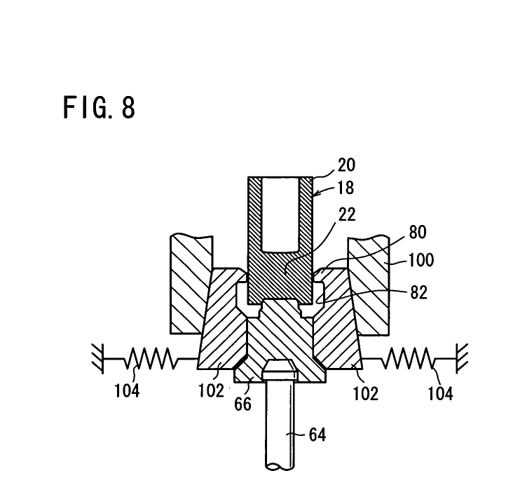

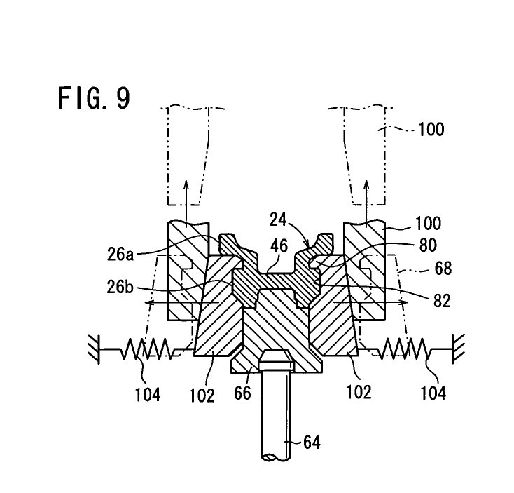

For example, as shown in FIGS. 8 and 9, a ring member 100 vertically movable in unison with the punch 90 by a coupling mechanism, not shown, may be used. For upsetting the member to be formed, split dies 102 may be tightened toward the center by the ring member 100. For opening the split dies, the ring member 100 may be lifted in unison with the punch 90 and thereafter the split dies 102 may be displaced radially outwardly by being pulled by spring members 104.

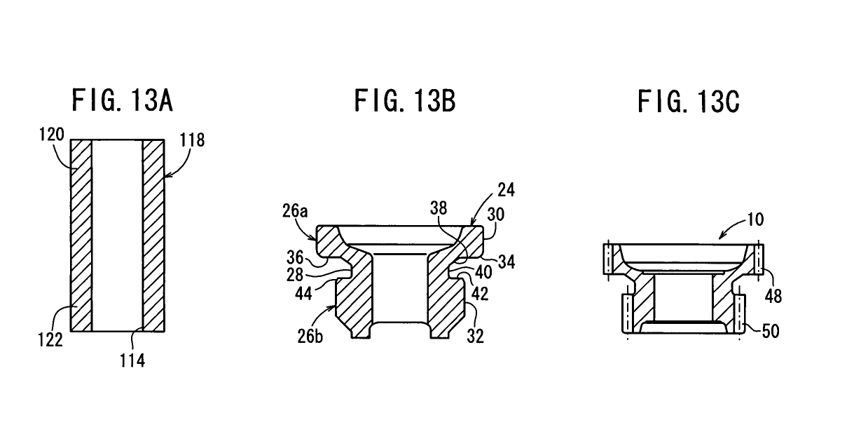

FIGS. 13A through 13C show a process of manufacturing a transmission gear to which a method of manufacturing a formed article with an undercut according to another embodiment of the present invention is applied.

In the method of manufacturing a formed article with an undercut according to the other embodiment of the present invention, as shown in FIG. 13A, a hollow cylinder 118, such as a metal pipe etc., with a through hole 114 defined axially therein and having a constant inside diameter is prepared.

The hollow cylinder 118 has, on an axial end thereof, an upper annular side wall 120 extending a predetermined length parallel to the axial direction and having a predetermined wall thickness, and also has, on the other axial end thereof, a lower annular side wall 122 contiguous to the upper annular side wall 120 and extending a predetermined length parallel to the axial direction, the lower annular side wall 122 having the same wall thickness as the upper annular side wall 120. Stated otherwise, the hollow cylinder 118 has a uniform wall thickness along the axial direction and has its outside and inside diameters constant along the axial direction.

Then, the hollow cylinder 118, which serves as a member to be formed, is upset by a forging apparatus 160, thereby producing a form (formed article) 24 shown in FIG. 13B.

The form 24 shown in FIG. 13B is identical in shape to the form 24 shown in FIG. 1D. Specifically, the form 24 is identical to the form 24 shown in FIG. 1D in that it has a first upset portion 26a and a second upset portion 26b which are disposed respectively on axially opposite ends thereof and expand a predetermined length radially outwardly, and an undercut 28 disposed between the first upset portion 26a and the second upset portion 26b and defined as an annular recess which is recessed a predetermined length radially inwardly.

Then, the form 24 is machined to provide a first gear 48 and a second gear 50 respectively on the side walls 30, 32 of the first upset portion 26a and the second upset portion 26b. The entire body is now available as a transmission gear 10 (see FIG. 13C), as a product.

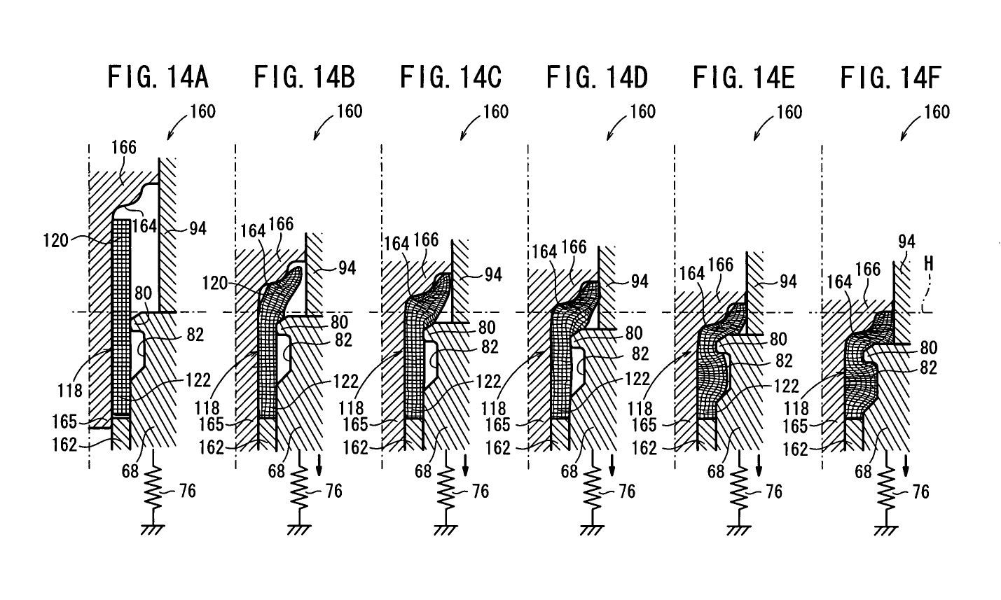

A process of upsetting the hollow cylinder 118 according to the method of manufacturing a formed article with an undercut according to the other embodiment of the present invention will be described in detail below with reference to FIGS. 14A through 14F.

Those parts of the forging apparatus 160 for performing the upsetting process which are identical to those of the second forging apparatus 60 shown in FIG. 3 are denoted by identical reference characters, and will not be described in detail below.

The forging apparatus 160 comprises a fixed die (fixed lower die) 162 in the form of a sleeve fixed to the die base 62, a punch 166 vertically movable with respect to the fixed die 162 and having, on a distal end thereof, a first forming portion 164 for plastically deforming the upper annular side wall 120 of the hollow cylinder 118 into a first upset portion 26a and a counter punch 165 contiguous to the first forming portion 164 and extending a predetermined length downwardly, and a plurality of circumferentially split dies 68 disposed laterally closely to the fixed die 162.

The split dies 68 are movable upwardly radially outwardly along a slanted surface (tapered surface) of a guide mechanism, not shown. When the split dies 68 are opened by moving upwardly radially outwardly, the upset form 24 is preferably released from the fixed die 162.

The split dies 68 are vertically displaceable by the biasing mechanism in the form of the spring members 69. When no load is applied to the split dies 68 and the upper surfaces of the split dies 68 are aligned with the dot-and-dash line H, the split dies 68 are in an initial position.

Each split die 68 has, on a region close to the fixed die 162, an undercut forming portion 80 in the form of an annular ridge projecting radially inwardly (in substantially the horizontal direction) for abutting against the boundary region between the upper annular side wall 120 and the lower annular side wall 122 of the hollow cylinder 118, and a second forming portion 82 in the form of an annular recess contiguous to and disposed below the undercut forming portion 80 for plastically deforming the lower annular side wall 122 of the hollow cylinder 118 radially outwardly into the second upset portion 26b.

The forging apparatus 160 uses the hollow cylinder 118 shown in FIG. 13A as a member to be formed. The hollow cylinder 118 is placed in a cavity defined by the fixed die 162 and the split dies 68. Then, a vertically moving mechanism, not shown, is actuated to lower the punch 166. As shown in FIG. 14A, the projecting counter punch 165 on the distal end of the punch 166 engages an inner wall of the hollow cylinder 118, and the first forming portion 164 of the punch 166 engages the upper annular side wall 120 of the hollow cylinder 118.

At this time, the undercut forming portions 80 of the split dies 68 are held in abutment against the boundary region between the upper annular side wall 120 and the lower annular side wall 122 on the outer surface of the hollow cylinder 118. The split dies 68 are not displaced downwardly, but are biased into the initial position by the biasing mechanism in the form of the spring members 76 or the like.

Then, as shown in FIGS. 14B and 14C, when the punch 166 is further lowered toward the fixed die 162, while the counter punch 165 of the punch 166 is engaging the inner wall of the hollow cylinder 118, the first forming portion 164 of the punch 166 starts a first upsetting process to spread the upper annular side wall 120 of the hollow cylinder 118 obliquely and radially-outwardly from the undercut forming portion 80. A material flow is now distributed into the first upset portion 26a and the second upset portion 26b from the region which is contacted by the undercut forming portion 80.

In the first upsetting process, the upper annular side wall 120 of the hollow cylinder 118 is plastically deformed complimentarily in shape to the first forming portion 164 of the punch 166, thereby forming the first upset portion 26a on one end. As shown in FIGS. 14B, and 14C, each split die 68 is gradually lowered against the spring force of the spring member 76, depending on a balance between the amount of deformation (extent of deformation) of the first upset portion 26a under the pressing force of the punch 166 and a forming force of the lower annular side wall 122 which has started to slightly spread radially outwardly into the second forming portion 82 under the pressing force of the punch 166.

Then, as shown in FIGS. 14D and 14E, when the punch 166 is further lowered, and the counter punch 165 of the punch 166 is engaging the inner wall of the hollow cylinder 118, a second upsetting process is performed to cause the first forming portion 164 of the punch 166 to press the lower annular side wall 122 of the hollow cylinder 118 to plastically deform the lower annular side wall 122 radially outwardly.

Specifically, as the first forming portion 164 of the punch 166 presses downwardly the lower annular side wall 122 of the hollow cylinder 118, a reactive force is generated to push the lower annular side wall 122 of the hollow cylinder 118 fixed by the fixed die 162 upwardly in the direction opposite to the direction in which the lower annular side wall 122 is pressed by the first forming portion 164. Under the reactive force, the bulging of the plastically deformed material is accelerated toward the second forming portions 82, in the form of annular recesses, of the split dies 168 (see FIGS. 14D and 14E).

Then, as shown in FIG. 14F, in the second upsetting process performed on the lower annular side wall 122 of the hollow cylinder 118 upon further downward movement of the punch 166 toward the fixed die 162, the plastically deformed material flows into and fills the entire second forming portions 82, in the form of annular recesses, of the split dies 68, thereby forming the second upset portion 26b on the other end.

The split dies 68 are held in a prescribed position where a first upsetting force and a second upsetting force are in a state of balance. Specifically, the split dies 68 held in a floating state by the biasing mechanism in the form of the spring members 76 are gradually lowered depending on the amount of deformation of the first upset portion 26a that is produced when the upper annular side wall 120 is plastically deformed under the pressing force of the punch 166 and the amount of deformation of the second upset portion 26b that is produced when the lower annular side wall 122 is slightly expanded under the pressure of the punch 166. Thereafter, the split dies 68 are held in the prescribed position when the first upsetting force tending to plastically deform the upper annular side wall 120 and the second upsetting force tending to plastically deform the upper annular side wall 122 are brought into a state of balance (see FIG. 14F).

As a result, as shown in FIG. 13B, the form 24 is produced which includes the first upset portion 26a and the second upset portion 26b which are disposed respectively on the axially opposite ends thereof and expand a predetermined length radially outwardly and the undercut 28 disposed between the first upset portion 26a and the second upset portion 26b.

In the method of manufacturing a formed article with an undercut according to the other embodiment, the hollow cylinder 118 is placed in a floating state by the split dies 68 biased by the biasing mechanism in the form of the spring members 76, and a simple process is performed by axially pressing the hollow cylinder 118 with the single punch 166. According to the simple process, the form 24 is produced which includes the first upset portion 26a and the second upset portion 26b which are substantially simultaneously formed respectively on the axially opposite ends thereof and the undercut 28 disposed between the first upset portion 26a and the second upset portion 26b.

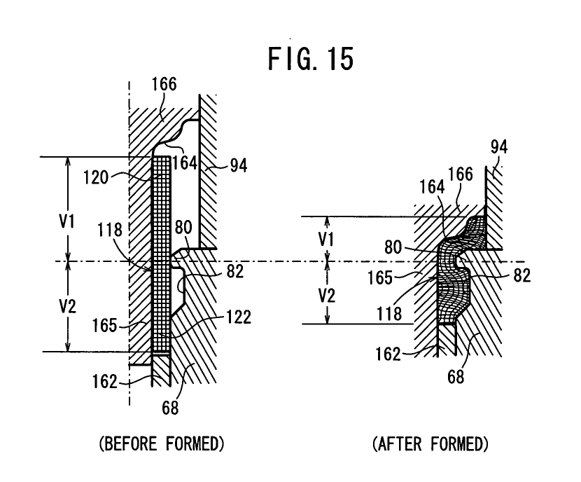

If the member to be formed comprises a metal pipe (hollow cylinder 118), then, as shown in FIG. 15, no material flow occurs between the first upset portion 26a and the second upset portion 26b across the undercut forming portion 80, and an upper volume V1 and a lower volume V2, which are positioned respectively on either sides of the boundary of the undercut forming portion 80, of the pipe before it is formed, are identical to an upper volume V1 and a lower volume V2, respectively, of the formed body. Therefore, if the member to be formed comprises a pipe, then it is easy to establish conditions for distributing the material to the first upset portion 26a and the second upset portion 26b.

1. A method of manufacturing a formed article with an undercut, comprising the steps of:
placing an intermediate form, as a member to be formed, including a hollow cylindrical annular side wall extending a predetermined length along an axial direction thereof and a solid body contiguous to said annular side wall, in a cavity defined by a fixed die and a plurality of split dies displaceable by a biasing mechanism;
lowering a punch to perform a first upsetting process to cause a first forming portion of said punch to plastically deform said annular side wall of the member to be formed radially outwardly while said split dies surrounding said member to be formed are being lowered, thereby forming a first upset portion on an axial end of said member to be formed; and
further lowering said punch to perform a second upsetting process to cause said punch to abut against and press said solid body of said member to be formed, so as to plastically deform said solid body radially outwardly while said split dies surrounding said member to be formed are being lowered, causing a plastically deformed material of the solid body to flow into and fill second forming portions of said split dies, thereby forming a second upset portion on an axial other end of said member to be formed, and causing undercut forming portions of said split dies to form an undercut between said first upset portion and said second upset portion.

2. A method according to claim 1, wherein a material flow is distributed between said first upset portion and said second upset portion by the undercut forming portions of said split dies, said undercut forming portions abutting against a boundary region between said annular side wall and said solid body of said member to be formed.

3. A method of manufacturing a formed article with an undercut, comprising the steps of:
placing a hollow cylinder, as a member to be formed, including an upper annular side wall extending a predetermined length along an axial direction thereof and a lower annular side wall contiguous to said upper annular side wall, in a cavity defined by a fixed die and a plurality of split dies displaceable by a biasing mechanism;
lowering a punch to perform a first upsetting process to cause a first forming portion of said punch to plastically deform said upper annular side wall of the member to be formed radially outwardly while said split dies surrounding said member to be formed are being lowered, thereby forming a first upset portion on an axial end of said member to be formed; and
further lowering said punch to perform a second upsetting process to cause said punch to press said lower annular side wall of said member to be formed, so as to plastically deform said lower annular side wall radially outwardly while said split dies surrounding said member to be formed are being lowered, causing a plastically deformed material of the lower annular side wall to flow into and fill second forming portions of said split dies, thereby forming a second upset portion on an axial other end of said member to be formed, and causing undercut forming portions of said split dies to form an undercut between said first upset portion and said second upset portion.

4. A method according to claim 3, wherein a material flow is distributed between said first upset portion and said second upset portion by the undercut forming portions of said split dies, said undercut forming portions abutting against a boundary region between said upper annular side wall and said lower annular side wall of said member to be formed.

5. A forging apparatus for manufacturing a formed article with an undercut, comprising:
a member to be formed including a hollow cylindrical annular side wall extending a predetermined length along an axial direction thereof and a solid body contiguous to said annular side wall;
a plurality of circumferentially split dies surrounding said member to be formed and separable away from a formed article when the split dies are opened;
a lower die disposed centrally in said split dies for placing said member to be formed thereon;
a biasing mechanism for floatingly supporting said split dies; and
a single punch disposed coaxially with said lower die, said single punch being vertically movable;
said punch including a first forming portion for plastically deforming said annular side wall of the member to be formed radially outwardly and pressing said solid body against said lower die;
each of said split dies having, on an inner wall thereof, an undercut forming portion comprising an annular ridge for engaging a boundary region between said annular side wall and said solid body of said member to be formed, and a second forming portion comprising an annular recess contiguous to and disposed below said undercut forming portion.

6. A forging apparatus according to claim 5, wherein said biasing mechanism comprises a spring member, said spring member floatingly supporting a guide die member for guiding said split dies upwardly and radially-outwardly.

7. An intermediate form comprising a first upset portion formed on an axial end of a member to be formed by being pressed by a punch, a second upset portion formed on another axial end of the member to be formed by being pressed by the punch, and an undercut formed between said first upset portion and said second upset portion, wherein
said member to be formed comprises a hollow cylindrical annular side wall extending a predetermined length along an axial direction thereof and a solid body contiguous to said annular side wall.
